(19) United States
(12) Patent Application Publication
(10) Pub. No.: US 2016/0126003 A1
(43) Pub. Date: May 5, 2016

(54) MULTILAYER INDUCTOR

(71) Applicant: SAMSUNG ELECTRO-MECHANICS CO., LTD., Suwon-Si (KR)

(72) Inventor: Bong Sup LIM, Suwon-Si (KR)

(21) Appl. No.: 14/869,969

(22) Filed: Sep. 29, 2015

(30) Foreign Application Priority Data
Nov. 4, 2014 (KR) 10-2014-0151922

(51) Int. Cl. H01F 27/28

(52) U.S. Cl. CPC H01F 27/2804; H01F 2027/2809

(57) ABSTRACT

A multilayer inductor includes: a body; and internal electrodes disposed within the body and connected to each other through conductive vias, wherein widths of the internal electrodes have two or more different values within a range of 35 μm to 55 μm, and the internal electrodes include a first internal electrode and a second internal electrode having a width different from that of the first internal electrode.

### CROSS-REFERENCE TO RELATED APPLICATION

This application claims the benefit of Korean Patent Application No. 10-2014-0151922 filed on Nov. 4, 2014, with the Korean Intellectual Property Office, the disclosure of which is incorporated herein by reference.

### BACKGROUND

The present disclosure relates to a multilayer inductor.

An inductor, which is one of the main passive elements constituting, together with a resistor and a capacitor, an electronic circuit, is used to remove noise or used as a component constituting an LC resonance circuit.

Inductors may be classified into a winding type inductor which is manufactured by winding a coil around a ferrite core or printing and forming electrodes on both ends thereof, or a multilayer type inductor which is manufactured by printing internal electrodes on magnetic layers or dielectric layers and then stacking the magnetic layers or the dielectric layers.

Multilayer inductors, which are becoming increasingly prevalent, have a structure in which a plurality of magnetic layers or a plurality of dielectric layers with internal electrodes formed thereon are stacked as mentioned above, and the internal electrodes are sequentially connected by via electrodes formed in the layers to form an overall coil structure, thus obtaining characteristics such as target inductance and impedance.

In the related art, in order to obtain target inductance and impedance, the number of turns of the internal electrodes and/or lengths of the internal electrodes have been adjusted. This method, however, increases loss of magnetic flux.

### SUMMARY

An aspect of the present disclosure may provide a multilayer inductor in which loss of magnetic flux is prevented and inductance is adjusted by adjusting widths of internal electrodes.

According to an aspect of the present disclosure, a multilayer inductor may include internal electrodes of which widths are adjusted to have two or more different values within a range of 35 μm to 55 μm.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a perspective view of a multilayer inductor according to an exemplary embodiment in the present disclosure;

FIG. 2 is an exploded perspective view of the multilayer inductor of FIG. 1;

FIG. 3 is a cross-sectional view of the multilayer inductor taken along line A-A′ of FIG. 1; and

FIG. 4 is an exploded perspective view of a multilayer inductor according to another exemplary embodiment in the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

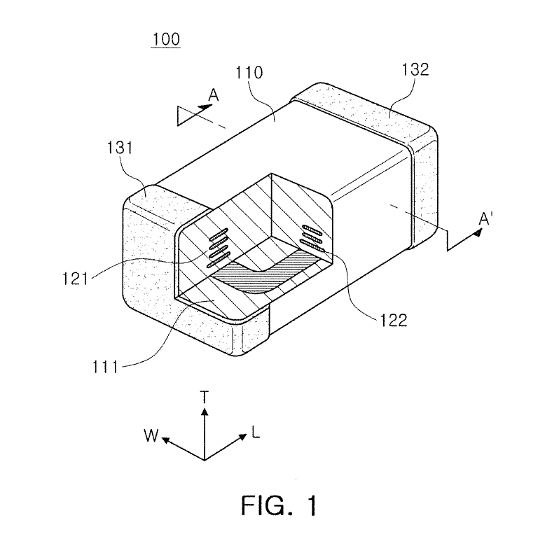

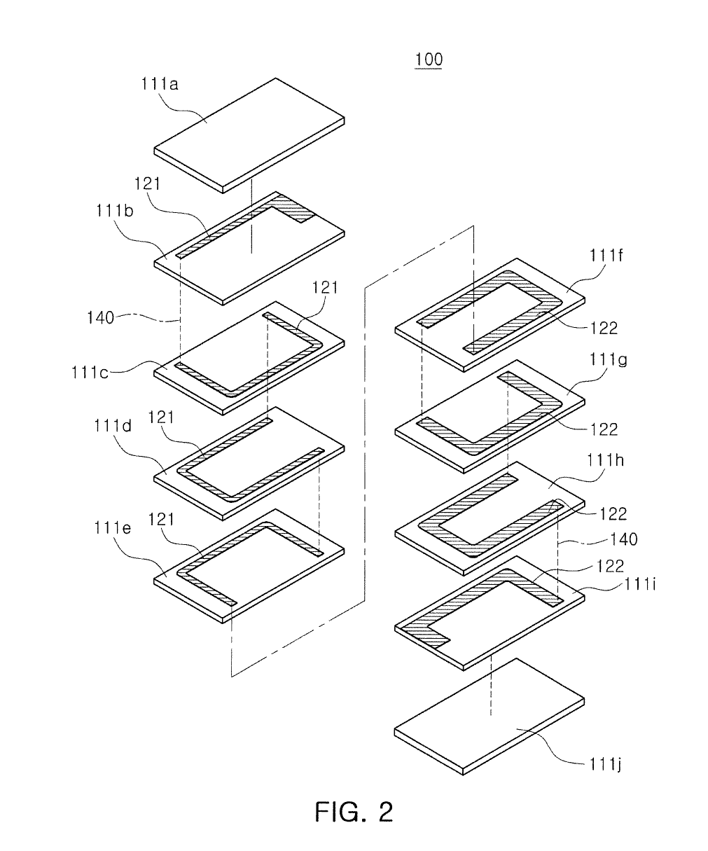

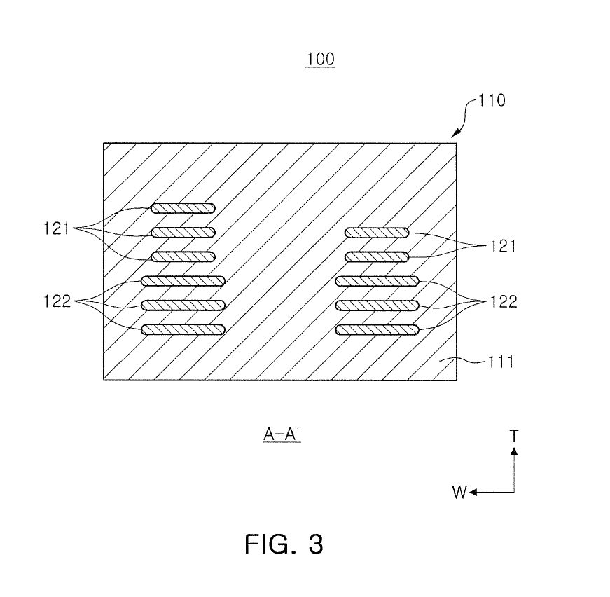

FIG. 1 is a perspective view of a multilayer inductor 100 according to an exemplary embodiment, FIG. 2 is an exploded perspective view of the multilayer inductor 100 of FIG. 1, and FIG. 3 is a cross-sectional view of the multilayer inductor 100 taken along line A-A′ of FIG. 1.

In order to clarify the exemplary embodiments, “L,” “W,” and “T,” defining directions of a hexahedron shown in FIG. 1, indicate a length direction, a width direction, and a thickness direction, respectively.

Referring to FIGS. 1 through 3, the multilayer inductor 100, according to an exemplary embodiment, includes a body 110 and internal electrodes 121 and 122 disposed within the body 110 and connected through via electrodes 140. Also, widths of the internal electrodes 121 and 122 may have two or more different values within a range of 35 μm to 55 μm.

The body 110 may include magnetic layers 111 and the internal electrodes 121 and 122 disposed on the magnetic layers 111. One of the ends of the internal electrodes 121 and 122 may be exposed to one side surface of the body 110 and the other of the ends thereof may be exposed to the other side surface of the body. Also, the body 110 may further include external electrodes 131 and 132 electrically connected to portions of the internal electrodes 121 and 122 externally exposed to the outside of the body 110.

Referring to FIG. 2, the body 110 may be a laminate in which a plurality of sheets including ceramic layers, magnetic layers, and non-magnetic or dielectric layers are stacked, and may have a rectangular-parallelepiped shape or a shape similar thereto. The body 110 may be manufactured by printing the internal electrodes 121 and 122 on magnetic sheets 111a to 111j, stacking the magnetic sheets 111a to 111j with the internal electrodes 121 and 122 formed thereon, and sintering the magnetic sheets 111a to 111j.

The magnetic sheets 111a to 111j may have magnetic or non-magnetic properties. When the magnetic sheets 111a to 111j are formed of a magnetic material, the magnetic sheets 111a to 111j may include ferrite. Ferrite may be appropriately selected according to magnetic characteristics required for an electronic component, and ferrite having a high degree of resistivity and a relatively low degree of core loss may be advantageous. For example, an Ni-Zu-Cu-based ferrite may be used, and a dielectric having a dielectric constant of about 5 to 100 may be used. When the magnetic sheets 111a to 111j are formed of a non-magnetic material, the magnetic sheets 111a to 111j may be formed of a ceramic material including zirconium silicate, potassium zirconate, or zirconium.

Internal electrodes 121 and 122 are not formed on some of the magnetic sheets 111a to 111j forming the body 110. In particular, the magnetic sheets 111a and 111j, constituting the uppermost and lowermost layers of the body 110, respectively, may not include the internal electrodes 121 and 122 in order to protect the body 110.

A thickness and a stacking number of the magnetic sheets 111a to 111j constituting the body 110 may be variously modified in consideration of a magnitude of target inductance or impedance.

The internal electrodes 121 and 122 may be formed on the plurality of magnetic sheets 111b to 111i. The internal electrodes 121 and 122 formed on the magnetic sheets 111b to 111i may be electrically connected by the via electrodes 140 to form a single coil, thus forming inductance or impedance.

The ends of the internal electrodes 121 and 122 formed on the uppermost magnetic sheet 111b and on the lowermost magnetic sheet 111i, among the magnetic sheets 111b to 111i which are provided with the internal electrodes 121 and 122, may extend to the respective outer edges of the magnetic sheets 111b and 111i. Thus, when the body 110 is formed by stacking the magnetic sheets 111a to 111j, the ends of the internal electrodes 121 and 122 may respectively be externally exposed to the outside of the body 110 and electrically connected to the respective external electrodes 131 and 132 disposed externally from the body 110. Here, connection electrodes may be disposed on the portions of the internal electrodes 121 and 122 reaching the outer edges of the magnetic sheets 111b and 111i. The connection electrodes may be formed to be wider than those of other portions of the internal electrodes 121 and 122 to facilitate connections to the external electrodes 131 and 132 and to be advantageous in obtaining electrical characteristics, such as impedance.

The internal electrodes 121 and 122 may be formed of a conductive material, and may be formed of at least one of silver (Ag), platinum (Pt), palladium (Pd), copper (Cu), gold (Au), nickel (Ni), or alloys thereof.

The external electrodes 131 and 132 are disposed on portions of the body 110 to which the internal electrodes 121 and 122 are externally exposed. Accordingly, the external electrodes 131 and 132 are electrically connected to the internal electrodes 121 and 122, respectively. The external electrodes 131 and 132 may be formed by immersing the body 110 in conductive paste, or printing, depositing, or sputtering the external electrodes 131 and 132 on outer surfaces of the body 110 with conductive paste. The conductive paste may include silver (Ag), silver-palladium (Ag—Pd), nickel (Ni), or copper (Cu). Also, if necessary, a nickel or tin plated layer may further be formed on the surfaces of the external electrodes 131 and 132.

As mentioned above, in the multilayer inductor 100, the internal electrodes 121 and 122 are sequentially connected by the via electrodes 140 formed in the layers to form an overall coil structure, thus obtaining electrical characteristics such as target inductance or impedance. In the related art, in order to obtain target inductance or impedance, the number of turns of the internal electrodes and/or lengths of the internal electrodes have been adjusted. This method, however, increases loss of magnetic flux.

In an exemplary embodiment, by adjusting the widths of the internal electrodes 121 and 122, inductance may be adjusted and loss of magnetic flux may be prevented.

Table 1 illustrates changes in inductance in relation to changes in widths of the internal electrodes 121 and 122 of the multilayer inductor 100. Inductance values were measured by adjusting the widths of the internal electrodes 121 and 122 and the number of turns of the internal electrodes 121 and 122 of the multilayer inductor 100 of a 0.6 mm×0.3 mm size under a condition of 500 MHz.

TABLE 1

| Number of Turns | Inductance Value (nH) according to Widths of | | | | |
|---|---|---|---|---|---|
| of Internal | Internal Electrodes | | | | |
| Electrodes | 25 μm | 35 μm | 45 μm | 55 μm | 65 μm |
| 4 | 7.82 | 7.69 | 7.44 | 7.25 | 7.11 |
| 5 | 10.55 | 10.25 | 9.92 | 9.63 | 9.12 |
| 6 | 14.23 | 13.21 | 12.65 | 12.34 | 10.54 |
| 7 | 18.94 | 16.24 | 15.32 | 14.87 | 11.46 |
| 8 | 23.43 | 19.6 | 18.36 | 17.65 | 13.21 |
| 9 | 28.04 | 22.91 | 21.53 | 20.39 | 15.46 |

As illustrated in Table 1, it can be seen that, when the widths of the internal electrodes 121 and 122 were uniform, inductance values proportionally increased as the number of turns of the internal electrodes 121 and 122 increased. Also, it can be seen that, when the number of turns of the internal electrodes 121 and 122 was the same, inductance values increased as the widths of the internal electrodes 121 and 122 decreased.

According to Table 1, it can be seen that inductance values were adjusted by varying the widths of the internal electrodes 121 and 122 of the multilayer inductor 100. Since it is difficult to change the number of stacked layers in the multilayer inductor 100, the number of stacked layers is fixed to a specific value. Thus, it is also difficult to change the number of turns of the internal electrodes 121 and 122. According to Table 1, in order to increase or decrease the inductance value, the widths of the internal electrodes 121 and 122 may be adjusted, instead of changing the number of turns of the internal electrodes 121 and 122.

Also, according to Table 1, since the inductance value is changed in proportion to the number of turns of the internal electrodes 121 and 122, the number of turns of the internal electrodes 121 and 122 having widths changed to reach a target inductance value may be calculated.

The multilayer inductor 100 in which widths of at least one of the internal electrodes 121 and 122 are 35 μm, 45 μm, and 55 μm will be described by way of example.

When an approximate expression is obtained through a least squares method using the data of Table 1, it can be seen that, in a case in which the number of turns of the internal electrode having the width of 35 μm in the multilayer inductor 100 is n, an incremental value nH of inductance generated by the internal electrode having the width of 35 μm is obtained by 3.06×n.

When an approximate expression is obtained through the least squares method using the data of Table 1, it can be seen that, in a case in which the number of turns of the internal electrode having the width of 45 μm in the multilayer inductor 100 is m, an incremental value nH of inductance generated by the internal electrode having the width of 45 μm is obtained by 2.81×m.

When an approximate expression is obtained through the least squares method using the data of Table 1, it can be seen that, in a case in which the number of turns of the internal electrode having the width of 55 μm in the multilayer inductor 100 is l, an incremental value nH of inductance generated by the internal electrode having the width of 55 μm is obtained by 2.64×l.

In detail, in a case in which at least one of internal electrodes having a width of 45 μm is replaced with an internal electrode having a width of 35 μm in order to increase, by 1 nH, an inductance value of a multilayer inductor in which all internal electrodes have a width of 45 μm, an influence of the removed internal electrode having the width of 45 μm on the overall inductance is −2.81×m and an influence of the replacing internal electrode having the width of 35 μm on the overall inductance is +3.06×n. In this case, since the number of turns of the removed internal electrode having the width of 45 μm is the same as the number of turns of the replacing internal electrode having the width of 35 μm, n=m. Thus, when the value n is obtained from 3.06×n−2.81×m=1 nH, n=4. Therefore, when the internal electrode having the width of 45 μm is replaced with the internal electrode having the width of 35 μm by 4 turns, inductance may be increased by 1 nH.

As discussed above, in the multilayer inductor 100, according to an exemplary embodiment, the internal electrodes 121 and 122 may be formed to have widths of 35 μm, 45 μm, and 55 μm, whereby inductance may be adjusted by applying the foregoing formula.

Table 2 illustrates changes in inductance according to the number of stacked layers on the basis of Table 1.

TABLE 2

| | Widths of Internal Electrodes (μm) | | | | |
|---|---|---|---|---|---|
| | 25 | 35 | 45 | 55 | 65 |
| Incremental Inductance | 4.127 | 3.06 | 2.81 | 2.64 | 1.569 |
| per Number of Stacked | | | | | |
| Layers (nH) | | | | | |

According to Table 2, it can be seen that widths and the incremental inductance per number of stacked layers of the internal electrodes 121 and 122 having the widths of 35 μm to 55 μm decrease proportionally. However, it can be seen that the internal electrodes 121 and 122 having the width of 25 μm and the internal electrodes 121 and 122 having the width of 65 μm do not behave in line with the internal electrodes 121 and 122 having the widths of 35 μm to 55 μm, in relation to the widths and the incremental inductance per number of stacked layers. Thus, in order to change inductance by adjusting the widths of the internal electrodes 121 and 122, it is preferred to limit the widths of the internal electrodes 121 and 122 to be between 35 μm to 55 μm.

In Table 2, it can be seen that, when an approximate expression is obtained through the least squares method using the data of the internal electrodes 121 and 122 having the widths of 35 μm to 55 μm, the incremental inductance per number of stacked layers is changed by approximately −0.021 nH/μm according to the widths of the internal electrodes.

In a case in which the multilayer inductor 100 includes internal electrodes 121 and 122 having a ‘p’ number of different widths, the different widths are defined as W1, W2, W3, . . . , Wp, and the numbers of turns of the internal electrodes 121 and 122 having the widths of W1, W2, W3, . . . , Wp are defined as S1, S2, S3, . . . , Sp. When all the internal electrodes have the same width of W1, inductance is defined as Lb. Here, inductance Ls of the multilayer inductor 100 may be calculated by using Equation 1 below.

$$Ls = Lb + {\sum }_{r = 2}^{p} [ ( ( W 1 \times - 0.021 + 3.78 ) - ( Wr \times - 0.021 + 3.78 ) ) \times Sr ] \qquad [ Equation 1 ]$$

For example, in a case in which inductance of the multilayer inductor 100, in which the number of turns of the internal electrodes 121 and 122 having a width of 45 μm is five, is 9.92 nH, when two turns of the internal electrodes 121 and 122 having the width of 45 μm is replaced with the internal electrodes 121 and 122 having a width of 35 μm, inductance of the multilayer inductor 100 may be obtained as 9.5 nH by 9.92+[{45×(−0.021)+3.78}−{35×(−0.021)+3.78}]×2.

As described above, in the multilayer inductor 100, according to an exemplary embodiment, inductance may be adjusted by Equation 1 by forming the internal electrodes 121 and 122 to have widths of 35 μm and 55 μm.

Referring to FIG. 2, the width of the internal electrode 121 disposed on the magnetic sheets 111b to 111e differs from the width of the internal electrode 122 disposed on the magnetic sheets 111f to 111i. The internal electrode 121 disposed on the magnetic sheets 111b to 111e may be defined as a first internal electrode 121 and the internal electrode 122 disposed on the magnetic sheets 111f to 111i may be defined as a second internal electrode 122.

In the multilayer inductor 100, according to an exemplary embodiment, the widths of the first and second internal electrodes 121 and 122 may be within a range of 35 μm to 55 μm.

When the widths of the first and second internal electrodes 121 and 122 are one of 35 μm, 45 μm, and 55 μm, inductance may be adjusted by the Equation derived from Table 1, and thus, the widths of the first and second internal electrodes 121 and 122 may be one of 35 μm, 45 μm, and 55 μm. That is, the widths of the first and second internal electrodes 121 and 122 may be 35 μm and 45 μm, 35 μm and 55 μm, or 45 μm and 55 μm, respectively.

Also, when the widths of the first and second internal electrodes 121 and 122 are within a range of 35 μm to 55 μm, inductance may be adjusted by Equation 1, and thus, the widths of the first and second internal electrodes 121 and 122 may be equal to or greater than 35 μm and may be equal to or less than 55 μm.

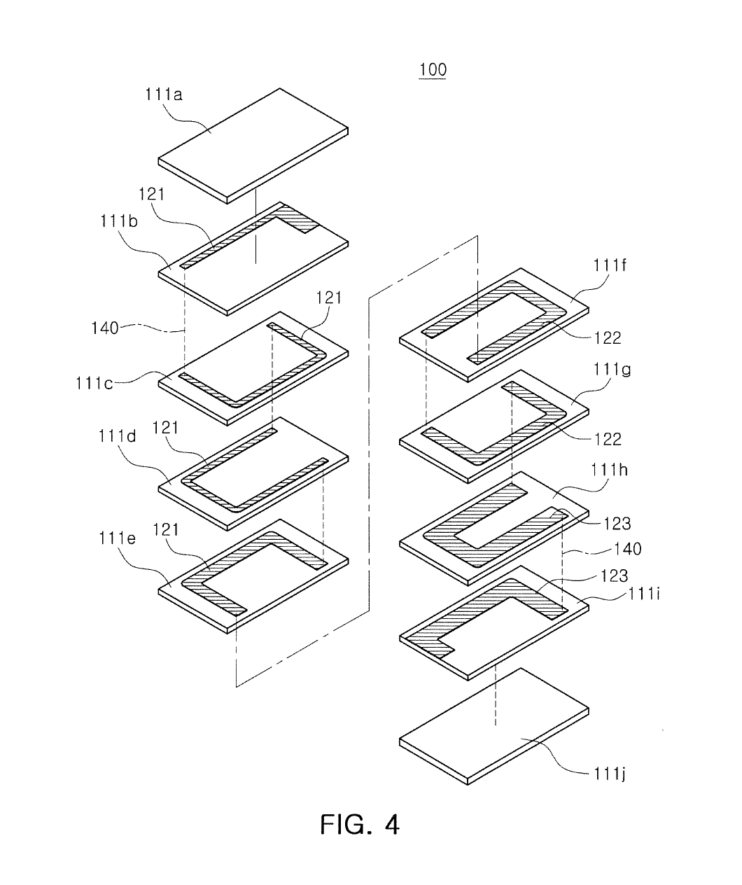

FIG. 4 is an exploded perspective view of a multilayer inductor 100 according to another exemplary embodiment.

Referring to FIG. 4, internal electrodes 121, 122, and 123 are classified into first internal electrodes 121, second internal electrodes 122 having a width different from that of the first internal electrodes 121, and third internal electrodes 123 having a width different from the widths of the first and second internal electrodes 121 and 122.

The widths of the first to third internal electrodes 121, 122, and 123 may range from 35 μm to 55 μm. Also, the widths of the first, second, and third internal electrodes 121, 122, and 123 may be 35 μm, 45 μm, and 55 μm, respectively.

As set forth above, according to exemplary embodiments, loss of magnetic flux may be prevented and inductance may be varied by adjusting widths of internal electrodes of the multilayer inductor.

While exemplary embodiments have been shown and described above, it will be apparent to those skilled in the art that modifications and variations could be made without departing from the spirit and scope of the present disclosure as defined by the appended claims.

What is claimed is:

1. A multilayer inductor comprising:
a body; and
internal electrodes disposed within the body and connected to each other through via electrodes,
wherein widths of the internal electrodes have two or more different values.

2. The multilayer inductor of claim 1, wherein the internal electrodes include:
a first internal electrode; and
a second internal electrode having a width different from that of the first internal electrode.

3. The multilayer inductor of claim 2, wherein the widths of the first and second internal electrodes range from 35 μm to 55 μm.

4. The multilayer inductor of claim 3, wherein the width of the first internal electrode is up to 10 μm less than the width of the second internal electrode.

5. The multilayer inductor of claim 3, wherein the width of the first internal electrode is between 10 μm to 20 μm less than the width of the second internal electrode.

6. The multilayer inductor of claim 1, wherein the internal electrodes includes:
a first internal electrode;
a second internal electrode having a width different from that of the first internal electrode; and
a third internal electrode having a width different from those of the first and second internal electrodes.

7. The multilayer inductor of claim 6, wherein the widths of the first to third internal electrodes range from 35 μm to 55 μm.

8. The multilayer inductor of claim 7, wherein the width of the first internal electrode is 35 μm,
the width of the second internal electrode is 45 μm, and
the width of the third internal electrode is 55 μm.

9. The multilayer inductor of claim 1, wherein when a width of at least one of the internal electrodes is 35 μm and the number of turns of the internal electrode having the width of 35 μm is n, an incremental value (nH) of inductance generated by the internal electrode having the width of 35 μm is calculated by using 3.06×n.

10. The multilayer inductor of claim 1, wherein when a width of at least one of the internal electrodes is 45 μm and the number of turns of internal electrode having the width of 45 μm is m, an incremental value (nH) of inductance generated by the internal electrode having the width of 45 μm is calculated by using 2.81×m.

11. The multilayer inductor of claim 1, wherein when a width of at least one of the internal electrodes is 55 μm and the number of turns of internal electrode having the width of 55 μm is l, an incremental value (nH) of inductance generated by the internal electrode having the width of 55 μm is calculated by using 2.64×l.

12. A multilayer inductor comprising:
a body; and
internal electrodes stacked within the body and connected to each other through via electrodes,
wherein when widths of the internal electrodes have two or more different values within a range of 35 μm to 55 μm, the different widths of the internal electrodes are defined as W1, W2, W3, . . . , Wp, and the numbers of turns of the internal electrodes having the widths of W1, W2, W3, . . . , Wp are defined as S1, S2, S3, . . . , Sp, respectively, and when all the internal electrodes have the same width of W1, inductance is defined as Lb,
inductance Ls of the multilayer inductor is calculated by using the following equation:
$$Ls = Lb + {\sum }_{r = 2}^{p} [ ( ( W 1 \times - 0.021 + 3.78 ) - ( Wr \times - 0.021 + 3.78 ) ) \times Sr ]$$
